(19) United States
(12) Patent Application Publication
(10) Pub. No.: US 2008/0067864 A1
(43) Pub. Date: Mar. 20, 2008

(54) Vehicular hydraulic system with check valve

(76) Inventors: Albert C. Wong, Saginaw, MI (US); Tom C. Wong, Saginaw, MI (US); Rick L. Lincoln, Linwood, MI (US); James L. Davison, Freeland, MI (US)

Correspondence Address: MICHAEL D. SMITH;DELPHI TECHNOLOGIEES, INC., P.O. BOX 5052, MAIL CODE: 480-410-202, TROY, MI, 48007-5052, US

(21) Appl. No.: 11/901,823

(22) Filed: Sep. 19, 2007

Related U.S. Application Data
(60) Provisional application No. 60/845,899, filed on Sep. 20, 2006.

(51) Int. Cl. B60T 13/14; B60T 17/02; B62D 5/07

(52) U.S. Cl. 303/113.5; 180/6.3; 303/114.1

(57) ABSTRACT

A vehicular hydraulic system having a hydraulic pump, a first hydraulic application, a second hydraulic application and a hydraulic reservoir arranged in series. A check valve is positioned to allow the flow of fluid from a point between the second hydraulic application and the pump to a point upstream of the second hydraulic application when the fluid flow upstream of the second application has been significantly reduced. The first and second applications may be a hydraulic brake assist device and a steering gear assist device. The use of such a check valve may also be employed with a hydraulic system having a priority valve for diverting a portion of the fluid flow to the second application when the pressure upstream of the first application is elevated above a threshold value. The hydraulic system may also employ a pump that has a discharge rate that falls within a predefined range.

### CROSS REFERENCE TO RELATED APPLICATIONS

This application claims priority under 35 U.S.C. 119(e) of U.S. provisional patent application Ser. No. 60/845,899 filed on Sep. 20, 2006 entitled VEHICULAR HYDRAULIC SYSTEM WITH CHECK VALVE the disclosure of which is hereby incorporated herein by reference.

### BACKGROUND OF THE INVENTION

1. Field of the Invention

The present invention relates to hydraulic systems for vehicles and, more particularly, to a hydraulic system having a hydraulic fluid pump and at least two hydraulic applications.

2. Description of the Related Art

Many trucks with hydraulic braking systems, particularly larger gasoline powered and diesel powered trucks, incorporate hydraulic braking assist systems, rather than vacuum assist systems commonly found in passenger automobiles. The use of vacuum assist braking systems can be problematic in vehicles having a turbo-charged engine and such vehicles will also often employ hydraulic braking assist systems. Furthermore, there is an aftermarket demand for hydraulic braking assist systems for vehicles, such as hotrods, that may not otherwise have a brake assist device or for which the use of a vacuum assist system presents difficulties. Such hydraulic braking assist systems are well known and sold commercially.

Typically, these hydraulic braking assist systems are connected in series between the steering gear and hydraulic pump and use flow from the pump to generate the necessary pressure to provide brake assist as needed. The flow from the pump is generally confined within a narrow range of flow rates and is not intentionally varied to meet changing vehicle operating conditions. Because of the series arrangement, the application of the brakes and engagement of the hydraulic braking assist system can affect the flow of hydraulic fluid to the steering gear, thereby affecting the amount of assist available to the steering gear. Specifically, when a heavy braking load is applied, it causes an increase in pressure to the pump which can exceed a threshold relief pressure (e.g., 1,500 psi) of the pump. Above this level, a bypass valve of the pump opens to divert a fraction of the outflow back to the intake of the pump, where the cycle continues until the pressure from the brake assist device drops below the threshold value of the bypass valve. During this relief condition, a diminished flow of fluid is sent to the steering gear which may result in a detectable increase in steering effort by the operator of the vehicle to turn the steering wheel under extreme relief conditions.

To at least partially alleviate this condition, it is possible to place a flow-splitter or priority valve in the hydraulic system to divert a portion of the flow of fluid being discharged from the pump to the steering gear under heavy braking conditions. The disclosure of U.S. Pat. No. 6,814,413 B2 describes the use of such a flow-splitter and is hereby incorporated herein by reference.

### SUMMARY OF THE INVENTION

The present invention provides a vehicular hydraulic circuit with first and second hydraulic applications arranged in series and a one-way check valve arranged in parallel with the second application to ensure a relatively free flow of hydraulic fluid to a second hydraulic application.

The present invention comprises, in one form thereof, a vehicular hydraulic system with a hydraulic circuit having, arranged in series and in serial order along a primary flow path, a hydraulic pump, a flow-splitting valve, a first hydraulic application, a second hydraulic application and a hydraulic reservoir. In a first operating condition, substantially all of the hydraulic fluid discharged from the pump is circulated along the primary flow path through the flow-splitting valve to the first hydraulic application. When the fluid in the primary flow path upstream of the first hydraulic application is elevated to a first threshold value, the flow-splitting valve splits the hydraulic fluid discharged by the pump into a first fluid flow which is communicated to the primary flow path upstream of the first hydraulic application and a second fluid flow which is communicated to a point in the primary flow path downstream of the first hydraulic application and upstream of the second hydraulic application. A one-way check valve is operably disposed in the hydraulic circuit parallel with the second hydraulic application. The check valve allows fluid flow from a first point in fluid communication with the primary flow path downstream of and proximate the second hydraulic application to a second point in fluid communication with the primary flow path upstream of and proximate the second hydraulic application when fluid pressure at the first point exceeds fluid pressure at the second point by a valve-actuating differential value.

The invention comprises, in another form thereof, a hydraulic system for a vehicle having an engine. The hydraulic system includes a hydraulic circuit having, arranged in series and in serial order along a primary flow path, a hydraulic pump, a hydraulic application and a hydraulic reservoir. The hydraulic pump is operably coupled to the vehicle engine and, at varying engine speeds above a predefined speed, the pump discharges hydraulic fluid into the primary flow path at a discharge rate within a predefined range. A one-way check valve is operably disposed in the hydraulic circuit parallel with the hydraulic application. The check valve allows fluid flow from a first point in fluid communication with the primary flow path downstream of and proximate the hydraulic application to a second point in fluid communication with the primary flow path upstream of and proximate the hydraulic application when fluid pressure at the first point exceeds fluid pressure at the second point by a valve-actuating differential value.

The invention comprises, in yet another form thereof, a hydraulic system for a vehicle having an engine. The hydraulic system includes a hydraulic circuit having, arranged in series and in serial order along a primary flow path, a hydraulic pump, a flow-splitting valve, a first hydraulic application, a second hydraulic application and a hydraulic reservoir. The hydraulic pump is operably coupled to the vehicle engine and wherein, at varying engine speeds above a minimal value; said pump discharges hydraulic fluid into the primary flow path at a substantially constant flow rate. A one-way check valve is operably disposed in the hydraulic circuit parallel with the second hydraulic application. The check valve allows fluid flow from a first point in fluid communication with the primary flow path downstream of and proximate the second hydraulic application to a second point in fluid communication with the primary flow path upstream of and proximate the second hydraulic application when fluid pressure at the first point exceeds fluid pressure at the second point by a valve-actuating differential value.

For some embodiments of the invention, the first hydraulic application may take the form of a hydraulic brake booster device and the second hydraulic application may take the form of a hydraulic steering gear device.

An advantage of the present invention is that it provides an effective and inexpensive means to ensure a relatively free flow of hydraulic fluid to a second hydraulic application arranged in series behind a first hydraulic application under conditions where the second application might not otherwise receive any hydraulic fluid.

### BRIEF DESCRIPTION OF THE DRAWINGS

The above mentioned and other features of this invention, and the manner of attaining them, will become more apparent and the invention itself will be better understood by reference to the following description of an embodiment of the invention taken in conjunction with the accompanying drawings, wherein:

FIG. 1 is a schematic view of a hydraulic system in accordance with the present invention.

FIG. 2 is a partial cross sectional view of a priority valve under normal flow conditions.

FIG. 3 is a partial cross sectional view of the priority valve of FIG. 2 wherein the priority valve is diverting a portion of the fluid flow through port C.

FIG. 4 is an enlarged schematic view of a portion of the hydraulic system of FIG. 1 illustrating the present invention.

FIG. 5 is an idealized graph which plots the discharge rate of the pump against the engine speed of the vehicle.

Corresponding reference characters indicate corresponding parts throughout the several views. Although the exemplification set out herein illustrates an embodiment of the invention, in one form, the embodiment disclosed below is not intended to be exhaustive or to be construed as limiting the scope of the invention to the precise form disclosed.

### DETAILED DESCRIPTION OF THE INVENTION

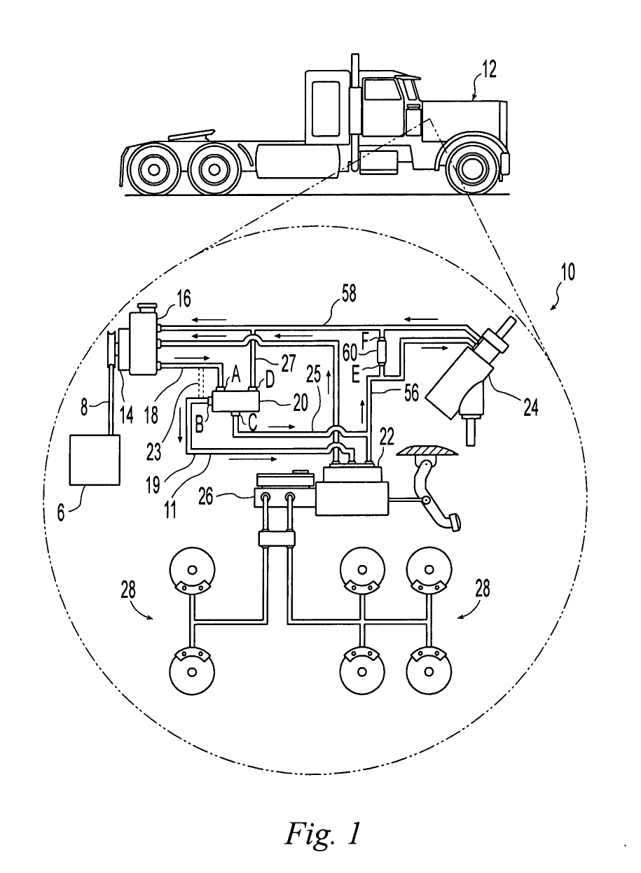

FIG. 1 shows a hydraulic system 10 for a vehicle 12 for assisting in the steering and braking of the vehicle. The hydraulic system includes a hydraulic pump 14 and reservoir 16. The reservoir may be incorporated into the pump 14, as illustrated, or may be located remote from the pump 14. In the illustrated embodiment, and as schematically depicted in FIG. 1, hydraulic pump 14 is operably coupled with the engine 6 of vehicle 12 with a belt 8.

The illustrated pump 14 is a conventional hydraulic pump and includes a flow control feature such that above a predefined operating speed of engine 6, pump 14 will discharge hydraulic fluid into discharge line 18 at a discharge rate that falls within a predefined range. FIG. 5 presents an idealized graph depicting the discharge rate of pump 14 plotted against the rotational speed of engine 6. Those having ordinary skill in the art will also recognize that the graph depicted in FIG. 5 is an idealized graph and the actual output of a hydraulic pump can be expected to include some deviation from this idealized representation.

As depicted in FIG. 5, as engine 6 begins operating and initially increases its speed, the discharge rate of pump 14 will initially increase linearly along with the engine speed. This linear relationship is depicted by portion 15a of the graph. Once engine 6 has surpassed a predefined engine speed the discharge curve will no longer have a linear relationship with the engine speed. This second portion of the discharge curve is labeled 15b in FIG. 5. Once the engine speeds have exceeded the linear portion 15a of the discharge curve, pump 14 will discharge fluid at a rate that falls between an upper limit 15bₘₐₓ and a lower limit 15bₘᵢₙ. Without a flow control feature, the discharge rate of pump 14 would continue to increase linearly as depicted by the dashed continuation of line 15a. By providing pump 14 with a flow control feature, however, the discharge rate of pump 14 remains within the range bounded by predefined upper limit 15bₘₐₓ and predefined lower limit 15bₘᵢₙ. The exemplary graph of FIG. 5 illustrates a pump having a substantially constant discharge rate (after reaching an operating speed corresponding to section 15b of the graph), however for some embodiments of the invention it may be desirable to purposefully vary the discharge rate as a function of the engine speed.

Pumps which can provide such a predefined range of discharge rates are well-known to those having ordinary skill in the art. For example, hydraulic pumps having a variable discharge orifice to control the discharge flow rate are well-known in the art. Some pumps having a variable orifice are referred to as “droop” pumps and have a discharge curve that has a maximum value at a relatively low engine speed and then, as the engine speed increases, falls to a lower discharge rate. An example of a flow control valve that can be used to provide a pump with such a discharge curve is disclosed by Minnis et al. in U.S. Pat. No. 4,251,193 the disclosure of which is expressly incorporated herein by reference. Generally, it is preferable to provide the steering gear with a higher flow of hydraulic fluid at slow vehicle velocities to provide greater assistance in turning the vehicle at slow speeds such as in parking maneuvers and a lesser flow at high vehicle velocities. A droop pump functions best with a steering gear when high engine speeds correspond to high vehicle velocities and low engine speeds correspond with low vehicle velocities which is not always the case. Other pumps having a variable orifice use an electronically controlled variable orifice which is adjusted based upon one or more operating parameters of the vehicle such as the vehicle velocity. An example of an electronic variable flow control valve is disclosed by Dinsmore et al. in U.S. Pat. No. 5,385,455 the disclosure of which is expressly incorporated herein by reference. Still other pumps may have other flow control features to limit the discharge flow rate of the pump to a predefined maximum value. See for example, the adjustable relief valve arrangement for a motor vehicle power steering hydraulic pump system disclosed by Can et al. in U.S. Pat. No. 5,651,665 the disclosure of which is expressly incorporated herein by reference.

With regard to the use of a positive displacement pump having a flow control feature, it is noted that typical values for upper limit 15bₘₐₓ and lower limit 15bₘᵢₙ for a vehicular hydraulic system could be approximately 4 gallon per minute and 1 gallon per minute respectively. It is further noted that the maximum discharge rate of a positive displacement pump, in the absence of a flow control feature to limit the discharge flow rate at high engine speeds, could be in excess of 20 gallons per minute.

The pump 14 delivers high pressure hydraulic fluid through discharge line 18 to a flow splitting valve 20 also referred to as a priority valve. The priority valve 20, in turn, selectively communicates with a first hydraulic application 22, a second hydraulic application 24, and the reservoir 16, depending on predetermined operating conditions of the system 10, as will be explained below.

The first and second hydraulic applications 22, 24 take the form of a hydraulic device or a hydraulic sub-circuit. In the illustrated embodiment, first application 22 is a hydraulic braking assist system or booster device and the second application 24 is a hydraulic steering gear assist system or device.

The hydraulic brake booster device 22 communicates with a master cylinder 26 and brakes 28 of the braking system. In the illustrated system 10, hydraulic brake booster device 22 and steering gear device 24 have relief pressures that are substantially equivalent. The hydraulic booster device 22 is of a type well known in the art which is disposed in line between the hydraulic pump and the hydraulic master cylinder of a vehicular hydraulic brake system which acts to boost or amplify the force to the brake system in order to reduce brake pedal effort and pedal travel required to apply the brakes as compared with a manual braking system. Such systems are disclosed, for example, in U.S. Pat. Nos. 4,620,750 and 4,967,643, the disclosures of which are both incorporated herein by reference, and provide examples of a suitable booster device 22. Briefly, hydraulic fluid from the supply pump 14 is communicated to the booster device 22 through a booster inlet port and is directed through an open center spool valve slideable in a booster cavity (not shown). A power piston slides within an adjacent cylinder and is exposed to a fluid pressure on an input side of the piston and coupled to an output rod on the opposite side. An input reaction rod connected to the brake pedal extends into the housing and is linked to the spool valve via input levers or links. Movement of the input rod moves the spool valve, creating a restriction to the fluid flow and corresponding boost in pressure applied to the power piston. Steering pressure created by the steering gear assist system 24 is isolated from the boost cavity by the spool valve and does not affect braking but does create a steering assist backpressure to the pump 14. The priority valve 20 operates to manage the flow of hydraulic fluid from the pump 14 to each of the brake assist 22 and steering assist 24 systems in a manner that reduces the interdependence of the steering and braking systems on one another for operation.

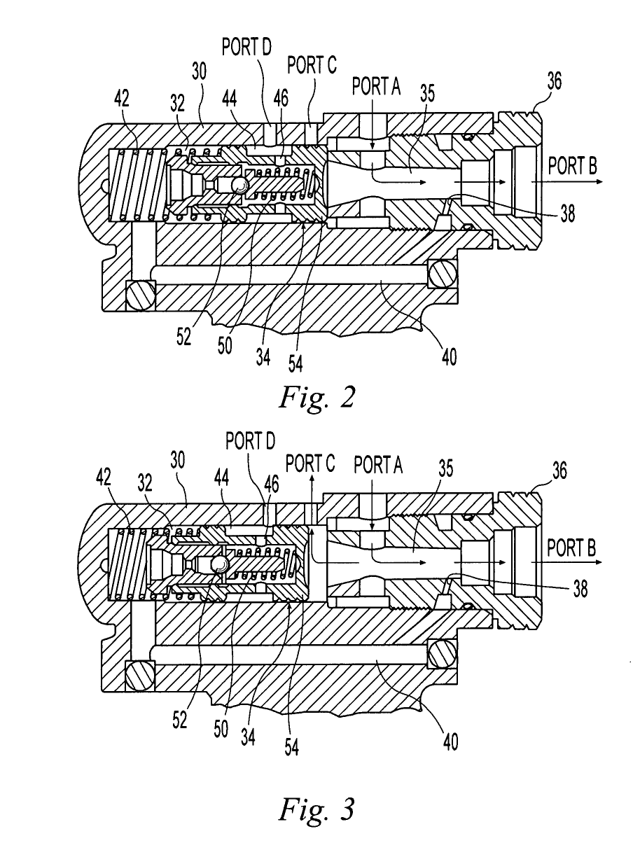

With reference to FIGS. 2 and 3, priority valve 20 includes a valve body 30 having a valve bore forming a chamber 32 in which a slideable flow control valve member 34 is accommodated. A plurality of ports are provided in the valve body 30, and are denoted in the drawing Figures as ports A, B, C and D. Fluid from the pump 14 is directed into the valve body 30 through port A, where it enters the chamber 32 and is directed out of the body 30 through one or more of the outlet ports B, C and D, depending upon the operating conditions which will now be described.

FIG. 2 shows normal operation of priority valve 20 under conditions where backpressure from the brake assist device 22 is below a predetermined threshold or control pressure. All of the flow entering port A passes through a primary channel 35 of the bore 32 of the flow splitter 20 and is routed through port B to the hydraulic brake booster 22. Of course, for all real devices, there is some inherent loss of fluid due to clearances between individual parts.

In the condition illustrated in FIG. 2, brake assist 22 is operating below the predetermined control or relief pressure value and the fluid flows freely into Port A and out Port B through the channel 35. As shown, the valve body 30 may be fitted with a union fitting 36 which extends into valve bore 32 and is formed with primary channel 35 in direct flow communication with valve bore 32. The line pressure in the primary channel 35 is communicated through a pressure reducing or P-hole orifice 38 in union fitting 36 and a communication passage 40 in the valve body 30 to the back of the flow control valve 34. This pressure, along with the bias exerted by a flow control spring 42 holds valve member 34 forward against union fitting 36. In this position, valve member 34 completely covers the bypass ports C, D to the steering assist 24 and reservoir 16, respectively, such that flow neither enters nor leaves these two ports. The valve member 34 has a reservoir pressure communication groove 44 that is always exposed to Port D and thus to the reservoir pressure which is communicated to Port D through hydraulic line 27 regardless of the position of valve member 34. This reservoir pressure is communicated to the inside of the valve through opening 46. A small poppet valve 50 separates the fluid at line pressure behind the valve member 34 from the fluid at the reservoir pressure inside valve member 34.

Turning now to FIG. 3, the condition is shown where the brake assist pressure developed by brake assist device 22 within Port B and the primary channel 35 exceeds the predetermined threshold pressure value for brake assist device 22, which is preferably set just below the relief pressure of pump 14. As the backpressure in primary channel 35 approaches the predetermined control pressure, the fluid pressure communicated to the back side of flow control valve member 34 will unseat a poppet ball 52 of poppet valve 50 which will cause some of the hydraulic oil to bleed behind the plunger 54 of valve member 34 and out to reservoir 16 through opening 46 in valve member 34 and Port D. Since P-hole orifice 38 is quite small, the communication passage pressure 40 will be lower than the line pressure within the primary channel 35 as long as the poppet valve 50 is open and bleeding oil from behind plunger 54. This pressure differential will cause plunger 54 to slide back against spring 42 from the position shown in FIG. 2 to the position shown in FIG. 3, thereby exposing Port C to the main flow of fluid discharged by pump 14 coming in through Port A. The flow from pump 14 in through Port A will thus be fed to both Port B and Port C with a significant majority of the flow being discharged through Port C bypassing the brake assist device 22 and being delivered to steering gear assist device 24 through hydraulic line 25. The flow control valve 34 thus operates to automatically meter excess oil flow through Port C when the backpressure generated by the brake assist device 22 rises to the preset control pressure which, as mentioned, is preferably set just under the relief pressure of the pump 14.

Priority valves having a different construction that divert hydraulic fluid flow such that the diverted fluid bypasses brake assist device 22 and is delivered to steering gear assist device 24 may also be employed with the present invention. For example, priority valves having a simplified construction that can be substituted for the illustrated priority valve 20 are described by Wong et al. in a U.S. patent application (Ser. No. ______) entitled VEHICULAR HYDRAULIC SYSTEM WITH PRIORITY VALVE AND RELIEF VALVE having an Attorney Docket Number of DP-315726 and claiming priority from U.S. Provisional Application Ser. No. 60/845,911 filed Sep. 20, 2006; and by Wong et al. in a U.S. patent application entitled VEHICULAR HYDRAULIC SYSTEM WITH PRIORITY VALVE having an Attorney Docket Number of DP-315727 and claiming priority from U.S. Provisional Application Ser. No. 60/845,892 filed Sep. 20, 2006, both of these utility applications having a common filing date with the present application, and wherein both of the utility applications and both of the provisional applications are assigned to the assignee of the present application and are expressly incorporated herein by reference.

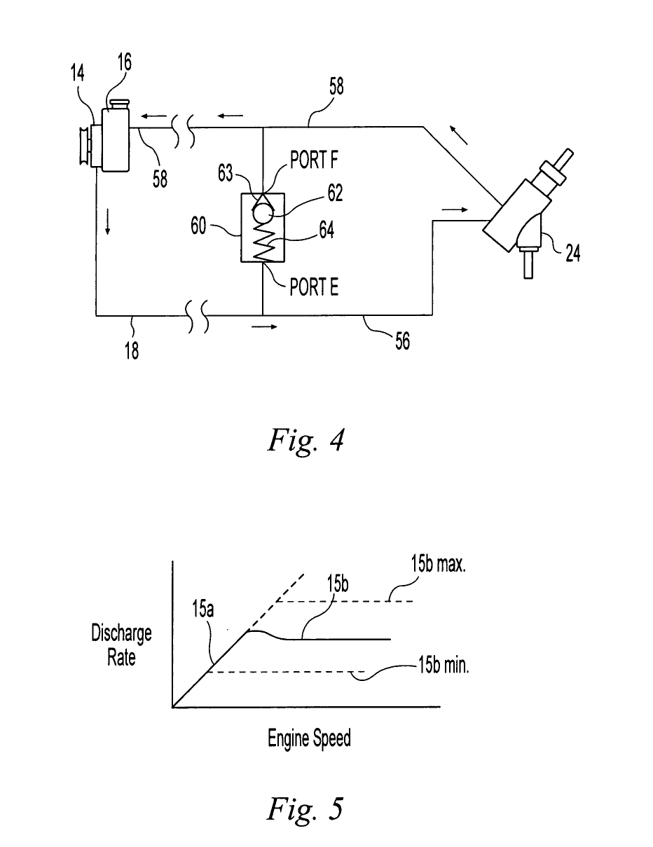

FIG. 4 illustrates check valve 60 which is in fluid communication with both hydraulic line 56, which conveys hydraulic fluid from the outlet of brake assist device 22 to the inlet of steering gear assist device 24, and hydraulic line 58 which conveys hydraulic fluid from the outlet of steering gear assist device 24 to reservoir 16. More specifically, Port E of check valve 60 is in fluid communication with line 56 and Port F of check valve 60 is in fluid communication with line 58. Check valve 60 is a low restriction one-way check valve that is positioned in hydraulic system 10 such that the flow of fluid from Port F to Port E is permitted when the fluid pressure at Port F exceeds the fluid pressure at Port E by a sufficient amount to overcome the biasing force exerted by spring 64. The illustrated check valve 60 is a conventional check valve having a ball member 62 and a spring 64 biasing ball 62 into sealing engagement with a valve seat 63. Other suitable check valve structures well known to those having ordinary skill in the art, however, may also be used with the present invention. For example, an electromechanical check valve or a check valve employing a spool could alternatively be employed with the present invention.

The pressure at Port E will correspond to the pressure in line 56 and at the inlet of device 24 while the pressure at Port F will correspond to the pressure in line 58 and in reservoir 16. The pressure differential by which the fluid pressure at Port F must exceed the fluid pressure at Port E to open check valve 60 is selected so that check valve 60 will open and thereby permit the flow of hydraulic fluid from line 58, through check valve 60, line 56 and to the inlet of steering gear assist device 24 when steering gear assist device 24 is experiencing low flow or no-flow conditions. Such low flow or no-flow conditions may arise from a variety of different circumstances, for example, pump 14 may not be operating normally, or, the operation of brake assist device 22 and/or priority valve 20 may be limiting the flow of hydraulic fluid to steering gear assist device 24. When steering gear device 24 is experiencing such low flow conditions, and the fluid pressure within line 56 drops to a low value, check valve 60 will open and permit the flow of hydraulic fluid from line 58 to steering gear device 24 and thereby allowing the recirculation of hydraulic fluid in close proximity to steering gear assist device 24. Both port E and port F are located in close proximity to steering gear device 24 to limit the distance the hydraulic fluid must travel through interconnecting hydraulic lines to provide such re-circulating flow as the manual turning of the steering wheel by the vehicle operator causes the discharge of fluid from steering gear device 24 into line 58 which may then be re-circulated to the inlet of steering gear device 24 through valve 60.

The flow of fluid to steering gear device 24 from line 58 through open check valve 60 is likely not to be as great as fluid flow to steering gear assist device 24 under normal operating conditions. The provision of some relatively free flowing hydraulic fluid to steering gear assist device 24, however, will enable steering gear assist device 24 to be actuated by the operator of vehicle 12 with relatively lower resistance to turning the steering wheel than he might otherwise encounter whereby the operator may be able to exercise greater control of vehicle 12 in what may be adverse operating conditions, e.g., operating conditions involving the heavy braking of vehicle 12.

Although the use of priority valve 20 is generally effective for ensuring a flow of hydraulic fluid to steering gear assist device 24 under adverse conditions such as heavy braking conditions, there may still be circumstances under which the flow of hydraulic fluid to steering gear assist device 24 is significantly reduced or eliminated. In such circumstances, the pressure in hydraulic line 56 which extends from the outlet of brake assist device 22 to the inlet of steering gear assist device 24 would be at a minimal value and check valve 60 would open thereby allowing the flow of hydraulic fluid from hydraulic line 58, through check valve 60 and to the inlet of steering gear assist device 24 through line 56.

It might also be desirable to include a check valve 60 in a hydraulic circuit that also includes a priority valve 20 to provide redundancy with respect to the diversion of a relatively free flow of at least some hydraulic fluid to steering gear assist device 24. In this regard, it is noted that the illustrated embodiment includes only two valves, i.e., flow-splitting valve 20 and check valve 60, which are not an integral part of pump 14, brake booster device 22 or steering gear device 24, yet which together provide a redundant system for ensuring fluid flow to steering gear device 24 under adverse operating conditions.

As evident from the description presented above, hydraulic circuit 10 includes, in series arrangement and in serial order, hydraulic pump 14, flow-splitting valve 20, brake booster device 22, steering gear device 24 and reservoir 16 with check valve 60 being arranged in parallel with steering gear device 24. When flow splitting valve 20 is not diverting a portion of the fluid flow through port C to bypass brake booster 22 as occurs when brake booster 22 is generating a relatively high back pressure, a substantial majority of the fluid flow discharged from pump 14 will flow along a primary flow path 11 that extends from the outlet of pump 14, through discharge line 18, through valve 20 from port A to port B, to brake booster 22 through hydraulic line 19, from brake booster 22 through hydraulic line 56 to steering gear 24, and from steering gear 24 through hydraulic line 58 to reservoir 16 and then to the inlet of pump 14 wherein the cycle is repeated. As described above, when the pressure upstream of brake booster 22 is elevated above a first threshold value, flow-splitting valve 20 will split the fluid flow with a portion being communicated to port B in the primary flow path upstream of brake booster 22 and another portion of the fluid flow being diverted through port C and hydraulic line 25 to a point in the primary flow path 11 downstream of brake booster device 22 and upstream of steering gear device 24.

As also described above, one-way check valve 60 is operably disposed in hydraulic circuit 10 in parallel with steering gear device 24. Inlet port F of check valve 60 is in fluid communication with the primary flow path 11 downstream of steering gear device 24 and outlet port E of valve 60 is in fluid communication with primary flow path 11 upstream of steering gear device 24. Valve 60 prevents the flow of fluid from port E to port F but allows the flow of fluid from port F to port E when the fluid pressure at port F exceeds the pressure at port E by a valve-actuating differential amount. It will generally be desirable to select a valve 60 wherein the pressure differential required to allow fluid flow from port F to port E is a very minimal value.

The present invention may also be implemented in various other hydraulic circuits. For example, the present invention is extremely well-suited for use in an integrated hydraulic circuit similar to that illustrated in FIG. 1 but wherein no priority valve 20 is provided. The Hydro-Boost™ system sold by the Robert Bosch Corporation is one example of such an integrated hydraulic circuit without a priority valve. More specifically, in such an alternative hydraulic circuit, discharge line 18 from pump 14 would extend directly from the discharge outlet of pump 14 to the inlet of brake assist device 22 as schematically depicted by dashed lines 23. Moreover, since there would be no priority valve 20, the branch hydraulic lines 25, 27 in communication with Ports C and D respectively of valve 20 would also be eliminated. In such a modified hydraulic circuit, when the backpressure generated by brake assist device 22 exceeded the threshold pressure of the bypass valve of pump 14, the pump bypass valve would open thereby diverting a portion of the fluid flow directly to the intake of pump 14. As a result, the flow of hydraulic fluid from the outlet of brake assist device 22 toward the intake of steering gear assist device 24 would be significantly reduced or eliminated altogether. In such a situation, check valve 60 would open permitting the flow of hydraulic fluid from line 58 through check valve 60 to the inlet of steering gear device 24.

Thus, the use of check valve 60 allows for the elimination of priority valve 20 while still ensuring that steering gear assist device 24 will continue to receive a relatively free flow of some hydraulic fluid when brake assist device 22 is generating significant backpressure on pump 14. Although check valve 60 would likely not provide the same quantity of fluid flow to steering gear assist device 24 under heavy braking conditions that the use of priority valve 20 would provide, the ability to eliminate priority valve 20 by the use of check valve 60 would provide significant cost savings while still providing significant advantages. Moreover, many integrated hydraulic circuits used to provide hydraulic fluid to both a brake assist device and a steering gear assist device do not include a priority valve similar to valve 20 and simply starve the steering gear assist device of hydraulic fluid under heavy braking conditions wherein the brake assist device has generated a backpressure greater than the threshold value of the bypass valve of the hydraulic pump. Consequently, the addition of a check valve 60 in such a circuit would enable the steering gear assist device to continue to receive a relatively free flow of at least some hydraulic fluid under adverse conditions wherein the fluid flow from the outlet of the brake assist device has become minimal or non-existent. Moreover, the lower cost of check valve 60 in comparison to priority valve 20, would enable the use of such a check valve in hydraulic circuits having a single pump and at least two hydraulic devices, e.g., a brake assist device and a steering gear assist device, for which the use of a priority valve 20 would be cost prohibitive.

While the present invention has been described above with reference to an integrated hydraulic system that combines both a steering gear assist device and a brake assist device, it may also be employed with other hydraulic devices and systems. For example, it is known to employ a single hydraulic fluid pump to power the fluid motor of a steering assist device and a second fluid motor associated with a radiator cooling fan. U.S. Pat. No. 5,802,848, for example, discloses a system having a steering gear assist device and a radiator cooling fan with a fluid motor powered by a single hydraulic fluid pump and is incorporated herein by reference. In alternative embodiments of the present invention, the check valve arrangement disclosed herein could be employed to facilitate the use of a single hydraulic fluid pump to power the fluid motors of both a steering gear assist device and that of a radiator cooling fan.

Additionally, the check valve arrangement of the present system could be used to control the fluid flow associated with a hydraulic device (e.g., a brake assist device, a steering gear assist device, a radiator fan having a fluid motor, or other hydraulic device), or hydraulic circuit, wherein the check valve arrangement and the associated hydraulic device or circuit, form one portion of a larger complex hydraulic circuit.

Furthermore, check valve 60 could also be employed in hydraulic circuits having a single hydraulic device. For example, FIG. 4 illustrates a fragmentary portion of circuit 10 which includes only one hydraulic device, i.e., device 24. If this fragmentary portion of circuit 10 were the entire circuit, then it would illustrate the use of a check valve 60 in a conventional steering system whereby check valve 60 would provide fluid flow to the steering gear assist device 24 from line 58 when the flow of fluid from pump 14 to the inlet of steering gear assist device 24 had been cut off or significantly diminished.

It is also possible for check valve 60 to be used in a hydraulic circuit having a reservoir disposed near pump 14 and a remote reservoir or sump disposed near check valve 60. This use of dual reservoirs would not only position a pool of hydraulic fluid near both pump 14 and check valve 60 but could also be used to increase the overall quantity of hydraulic fluid in the hydraulic circuit and thereby increase the heat sink capacity of the hydraulic fluid within the circuit.

While this invention has been described as having an exemplary design, the present invention may be further modified within the spirit and scope of this disclosure. This application is therefore intended to cover any variations, uses, or adaptations of the invention using its general principles.

What is claimed is:

1. A vehicular hydraulic system comprising:
a hydraulic circuit having, arranged in series and in serial order along a primary flow path, a hydraulic pump, a flow-splitting valve, a first hydraulic application, a second hydraulic application and a hydraulic reservoir;
wherein, in a first operating condition, substantially all of the hydraulic fluid discharged from said pump is circulated along said primary flow path through said flow-splitting valve to said first hydraulic application; and, when the fluid in said primary flow path upstream of said first hydraulic application is elevated to a first threshold value, said flow-splitting valve splits the hydraulic fluid discharged by said pump into a first fluid flow which is communicated to said primary flow path upstream of said first hydraulic application and a second fluid flow which is communicated to a point in said primary flow path downstream of said first hydraulic application and upstream of said second hydraulic application; and
a one-way check valve operably disposed in said hydraulic circuit parallel with said second hydraulic application; said check valve allowing fluid flow from a first point in fluid communication with said primary flow path downstream of and proximate said second hydraulic application to a second point in fluid communication with said primary flow path upstream of and proximate said second hydraulic application when fluid pressure at said first point exceeds fluid pressure at said second point by a valve-actuating differential value.

2. The vehicular hydraulic system of claim 1 wherein said first hydraulic application is a hydraulic brake booster device.

3. The vehicular hydraulic system of claim 1 wherein said second hydraulic application is a hydraulic steering gear device.

4. The vehicular hydraulic system of claim 1 wherein said first hydraulic application is a hydraulic brake booster device and said second hydraulic application is a hydraulic steering gear device.

5. The vehicular hydraulic system of claim 4 wherein valves operably disposed in said hydraulic circuit and non-integral with said pump, said brake booster device and said steering gear device consist solely of said flow-splitting valve and said one-way check valve.

6. A hydraulic system for a vehicle having an engine, said system comprising:
a hydraulic circuit having, arranged in series and in serial order along a primary flow path, a hydraulic pump, a hydraulic application and a hydraulic reservior;
wherein said hydraulic pump is operably coupled to the vehicle engine and, at varying engine speeds above a predefined value, said pump discharges hydraulic fluid into said primary flow path at a discharge rate within a predefined range; and
a one-way check valve operably disposed in said hydraulic circuit parallel with said hydraulic application; said check valve allowing fluid flow from a first point in fluid communication with said primary flow path downstream of and proximate said hydraulic application to a second point in fluid communication with said primary flow path upstream of and proximate said hydraulic application when fluid pressure at said first point exceeds fluid pressure at said second point by a valve-actuating differential value.

7. The hydraulic system of claim 6 wherein said hydraulic application is a hydraulic steering gear device.

8. A hydraulic system for a vehicle having an engine, said system comprising:
a hydraulic circuit having, arranged in series and in serial order along a primary flow path, a hydraulic pump, a flow-splitting valve, a first hydraulic application, a second hydraulic application and a hydraulic reservior;
wherein said hydraulic pump is operably coupled to the vehicle engine and, at varying engine speeds above a predefined value, said pump discharges hydraulic fluid into said primary flow path at a discharge rate within a predefined range; and
a one-way check valve operably disposed in said hydraulic circuit parallel with said second hydraulic application; said check valve allowing fluid flow from a first point in fluid communication with said primary flow path downstream of and proximate said second hydraulic application to a second point in fluid communication with said primary flow path upstream of and proximate said second hydraulic application when fluid pressure at said first point exceeds fluid pressure at said second point by a valve-actuating differential value.

9. The hydraulic system of claim 8 wherein said first hydraulic application is a hydraulic brake booster device.

10. The hydraulic system of claim 8 wherein said second hydraulic application is a hydraulic steering gear device.

11. The hydraulic system of claim 8 wherein said first hydraulic application is a hydraulic brake booster device and said second hydraulic application is a hydraulic steering gear device.

12. The hydraulic system of claim 11 wherein valves operably disposed in said hydraulic circuit and non-integral with said pump, said brake booster device and said steering gear device consist solely of said flow-splitting valve and said one-way check valve.

13. The hydraulic system of claim 8 further comprising a flow-splitting valve operably disposed downstream of said pump and upstream of said first hydraulic application wherein, in a first operating condition, substantially all of the hydraulic fluid discharged from said pump is circulated along said primary flow path through said flow-splitting valve to said first hydraulic application; and, when the fluid in said primary flow path upstream of said first hydraulic application is elevated to a first threshold value, said flow-splitting valve splits the hydraulic fluid discharged by said pump into a first fluid flow which is communicated to said primary flow path upstream of said first hydraulic application and a second fluid flow which is communicated to a point in said primary flow path downstream of said first hydraulic application and upstream of said check valve and said second hydraulic application.

14. The hydraulic system of claim 13 wherein said first hydraulic application is a hydraulic brake booster device.

15. The hydraulic system of claim 13 wherein said second hydraulic application is a hydraulic steering gear device.

16. The hydraulic system of claim 13 wherein said first hydraulic application is a hydraulic brake booster device and said second hydraulic application is a hydraulic steering gear device.

17. The hydraulic system of claim 16 wherein valves operably disposed in said hydraulic circuit and non-integral with said pump, said brake booster device and said steering gear device consist solely of said flow-splitting valve and said one-way check valve.
